(19) United States
(12) Patent Application Publication
(10) Pub. No.: US 2013/0337212 A1
(43) Pub. Date: Dec. 19, 2013

(54) RELEASE LABEL

(71) Applicant: Jeffrey Jensen, Easton, CT (US)

(72) Inventor: Jeffrey Jensen, Easton, CT (US)

(73) Assignee: ZADSPACE, Norwalk, CT (US)

(21) Appl. No.: 13/919,612

(22) Filed: Jun. 17, 2013

Related U.S. Application Data
(60) Provisional application No. 61/661,193, filed on Jun. 18, 2012.

(51) Int. Cl. G09F 3/00; G09F 3/10; B31D 1/02

(52) U.S. Cl. CPC G09F 3/0288; B31D 1/027; G09F 3/10
USPC 428/41.8; 156/277; 428/43

(57) ABSTRACT

An adhesive label consisting of a substrate having opposing first and second surfaces. The substrate including a first member having opposing first and second surfaces and a continuous side edge, and a second member having opposing first and second surfaces, an inner continuous side edge and an outer continuous side edge. A portion of the inner continuous side edge of the second member is removably attached to a portion of the side edge of the first member. The substrate further including a third member having opposing first and second surfaces and a continuous side edge wherein a first portion of the side edge of the third member is removably attached to a portion of the side edge of the first member such that the third member is configured as a tear-away tab.

### CROSS REFERENCE TO RELATED APPLICATIONS

This application claims priority to U.S. Patent Application Ser. No. 61/661,193 filed Jun. 18, 2012 which is incorporated herein by reference in its entirety.

### FIELD OF THE INVENTION

The invention generally relates to double-sided labels and methods of manufacture and use. More specifically, the invention relates to labels that include printed traces on their front sides and a tabbed detachable portion that non-permanently attaches to a product and includes printed traces on its back side.

### BACKGROUND OF THE INVENTION

Marketing programs are continually being developed, some of which rely on providing consumers with information directly on a product. Information often is attached to a product via a label. The information may include specific product information, e.g., ingredients, weight, directions for use, and cost. The information also may include market-related information such as advertising, recipes and coupons. Because the size of the product and/or the size of the label may be limited, efficient use of the label space is necessary to maximize the information available to the consumer.

Further, it may be desirable for a label to have a detachable portion so that a consumer can immediately use a portion of the label, e.g., a coupon redeemed at checkout, or save a portion of the label for fun reference, e.g., a recipe. Accordingly, there is a need in the art for labels having printing on both their front side and their back side where a portion of the label can be removed.

### SUMMARY OF THE INVENTION

The purpose and advantages of the invention will be set forth in and apparent from the description that follows. Additional advantages of the invention will be realized and attained by the devices, systems and methods particularly pointed out in the written description and claims thereof, as well as from the appended drawings.

To achieve these and other advantages and in accordance with the purpose of the invention, as embodied, the invention includes, in one aspect, a label that includes a release liner sheet and a substrate sheet removably laminated to the release liner sheet. The substrate sheet having opposing first and second surfaces and a first member having opposing first and second surfaces and a continuous side edge wherein the second surface disposed adjacent the liner sheet is provided with a deadened surface. Each of the opposing first and second surfaces is preferably provided with printed indicia, The substrate sheet further including a second member having opposing first and second surfaces, an inner continuous side edge and an outer continuous side edge wherein a portion of the inner continuous side edge is removably attached to a portion of the side edge of the first member. The second surface of the second member disposed adjacent the liner sheet is provided with an adhesive. The substrate sheet additionally includes a third member having opposing first and second surfaces and a continuous side edge wherein a first portion of the side edge of the third member is removably attached to a portion of the side edge of the first member. The third member is preferably configured as a tear-away tab to provide access to an open side edge of the first member so as to enable detachment of the first member from the substrate. The second surface of the third member disposed adjacent the liner sheet is also preferably provided with a deadened surface.

Additional aspects include machine formed perforations separating the first member from the second member, and the third member from each of the first and second members.

### BRIEF DESCRIPTION OF THE DRAWINGS

The accompanying appendices and/or drawings illustrate various non-limiting, example, inventive aspects in accordance with the present disclosure:

FIG. 1 illustrates a planar view of the label adhered to a product in accordance with an illustrated embodiment;

FIG. 2 illustrates a planar view of the back side of a first portion of a label when removed from the second portion; and

FIG. 3 depicts a side planar view of a substrate sheet having label retained against a release liner sheet.

### DETAILED DESCRIPTION OF CERTAIN EMBODIMENTS

The invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. It is noted that as used herein and in the appended claims, the singular forms “a”, “an,” and “the” include plural referents unless the context clearly dictates otherwise.

Generally, the invention relates to labels that include a front side and a back side; and at least a first portion and a second portion and a third portion; where the back side of the a first portion of the label is adapted to non-permanently contact a product or parcel and contains printed traces, and the back sides of the second portion is adapted to permanently attach to a product. As used herein, “product” may refer to an actual product (such as a consumer product) or a parcel (e.g., box) a consumer product is contained within. As also used herein, “permanently attached” refers to being attached to a product such that the detachable portion of the label can be removed from the other portions of the label without the other portions also being completely removed from the product, in other words, removal of the portion of a label that is permanently attached is difficult, but may be accomplished, e.g., by scraping the label using excessive force, or using chemicals. The label also includes printed information on its front side.

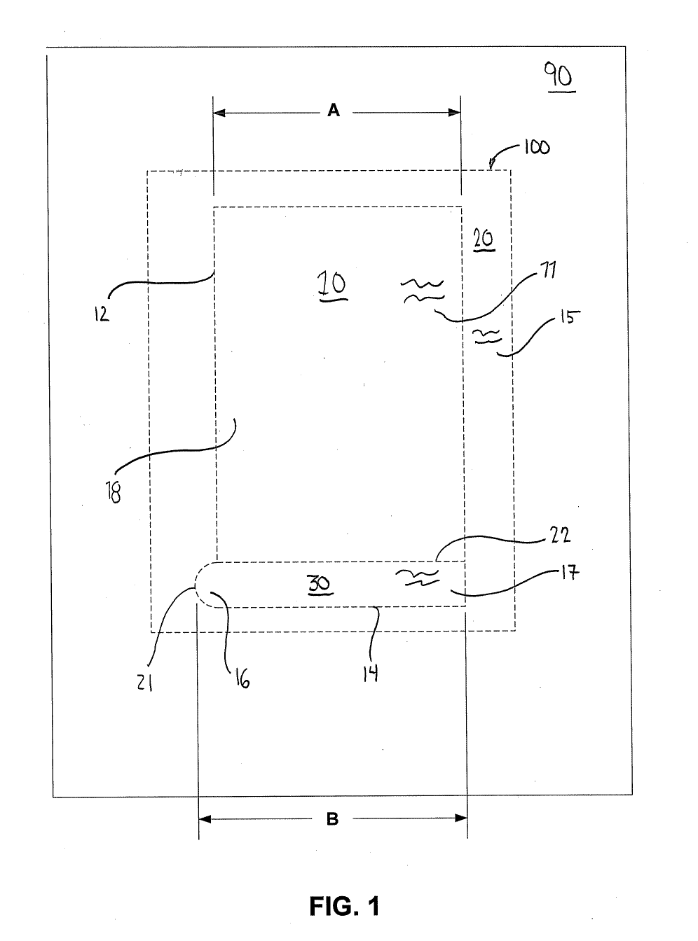

With reference now to FIG. 1, shown in an illustrated embodiment is an exemplary label 100 (e.g., a substrate) disposed on a product 90, which product may consist of a package or parcel to be sent from a sender to a recipient. The label 100 includes a first member 10, a second member 20 and a third member 30. The interface between the first member 10 and the second member 20 preferably includes machined perforations 12. Similarly, the interface between the first member 10 and the third member 30 includes machined perforations 14 forming a tabbed end section 16 such that third member 30 forms a removable tab, as discussed further below. The perforations may be machined cuts or apertures extending through the label 100. The front surface 11 of the first member 10 of the label 100 may include printed information 18 (e.g., indicia). Likewise, the front surface 15, 17 of the second and third member 20, 30 may also include printed information (e.g., indicia). An adhesive provided on the back surface of the second member 20 attaches the second member 20 to the product 90.

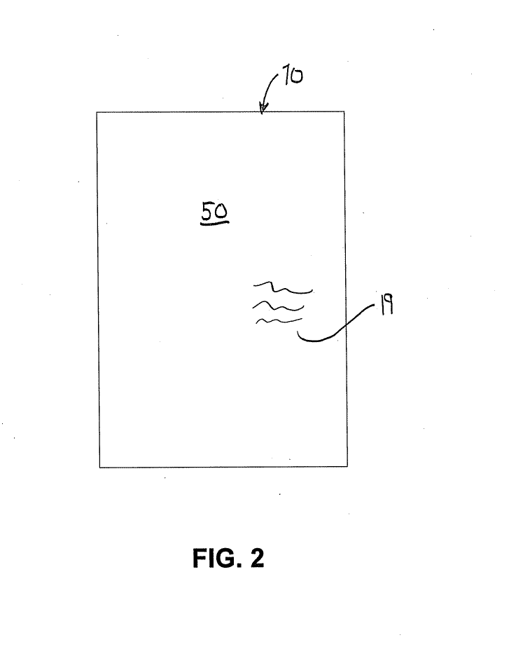

In order for a user to detach the first member 10 from the label 100 attached to a product 90, a user preferably accesses and tears away the tabbed third member 30 (via a pulling movement) attached proximate to the first and second members 10,20 along perforations 14. The first member 10 may then be pulled away and detached from the second member 20, and product 90, along perforations 12 to reveal printed information 50 on the back surface 19 of the first member 10 as shown in FIG. 2. That is, once the third tabbed member 30 is removed as mentioned above, a user creates and gains access to an open end 22 of the first member 10 and the perforations 12 disposed through the label 100 typically guide how the first member 10 peels and detaches from the second member 20 and product 90. It is noted the third member 30 is formed to have a width “B” greater than the width “A” of the first member 10 for user ease of access to a protruding tabbed end 21 of the third member 30.

In use, the printed information 50 on the back surface 19 of the first member 10, (e.g., a discount offer), may be processed for redemption after the first member 10 is detached from the remaining portions of the label 100.

It is to be understood a label may be composed of materials known in the art for making papers and labels. Materials employed to make the labels include paper that is laminated together, e.g., two or more types of paper may be laminated together to form the materials employed to make the labels. Suitable papers that may be employed are known to those skilled in the art. For instance, in certain embodiments, at least one layer of paper is a thermally activated paper. Alternatively, a thermal coating may be applied to paper used in a label.

A label may include printing on all or particular portions of its front surface and/or its back surface. As used herein, printing may include any colored ink printed on the label. Suitable inks that may be employed include liquid based inks, e.g., solvent-based or water-based inks.

In some embodiments, printing on the front surface defines printed information. Printed information may include one or more combinations of alphanumeric symbols, such as, words, offers, recipes, coupons, nutritional information and pictorial images, e.g., a bar code or a photograph of a product. A complementary product offered at a discount may be pictured on the front surface of a label 100 that is adhered to a product 90. Similarly, the back surface of the detachable portion of the label 100 may include printed information containing a redeemable coupon.

A label 100 may be printed using printing techniques known in the art for printing inks on paper and other substrates. Portions of the label 100 may be preprinted (such as the back surface 19 of the first member 10) and other portions may be printed on-site. Portions of the label 100 may be printed just prior to being applied to a product. Printing techniques that may be employed include, hut are not limited to, weigh scale printers, offset-lithographic (wet, waterless and dry), flexographic, rotogravure (direct or offset), intaglio, ink jet, electrophotographic (laser jet and photocopy), thermal and letterpress printing. Personal printers, e.g., ink jet and laser jet printers, also can be used to print information on substrates in accordance with the present invention.

In certain embodiments, a label 100 includes preprinted information on the front surface and/or back surface of the first member 10, and the front surfaces of the second member 20 and the third member 30 are printable regions that may be printed on-site.

Adhesive is preferably disposed on the back surface of the label 100, e.g., on the back surface of the second member 20. The adhesive enables the label to be permanently or removably attached to a product. Suitable adhesives include, but are not limited to, pressure sensitive adhesives.

The back surface 19 of the first member 10 of the label 100 may include printed traces, e.g., printing with colored ink. In some embodiments, the back surface 19 of the first member 10 includes printed information, such as alphanumeric characters or pictoral images, e.g., a bar code.

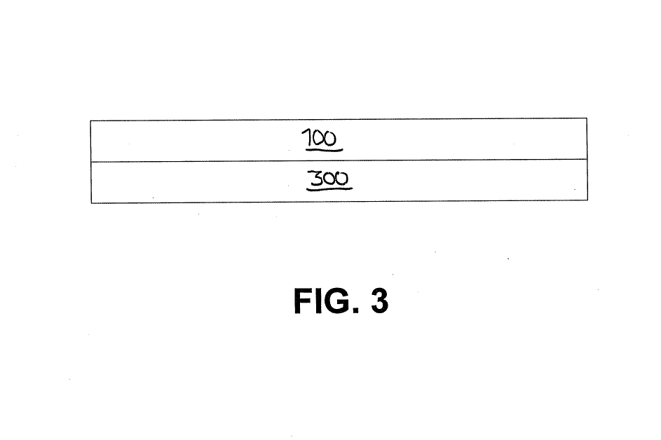

It is to be further understood a label 100 having a first member 10, a second member 20, and a third member 30 may be laminated to a release liner 300, as shown in FIG. 3. Specifically, the adhesive, disposed on the back surface of the second member 20 of the label 100, contacts the release liner 300. At least a portion of the release liner 300 may be coated with a release material, e.g., a silicon based coating. In one embodiment, the front surface (which contacts he back surface of label 100) of the release liner 300 is coated with a silicon based coating.

The label 100 typically is laminated to the release liner 300 so the adhesive on the back surface of the second member 20 of the label 100 is protected from contamination by substances, e.g., dust, that might reduce the adhesive properties of the label. Further, the release liner 300 enables the label 100 to be printed using one or more printing techniques without the adhesive on the back surface of the second member 20 of the label 100 becoming adhered to the printing apparatus. Additionally, the release liner 300 can enable the label 100 to be properly aligned and positioned in a printer for printing. It is noted, information (indicia) is printed on the back surface 19 of the first member 10 prior to the label 100 being adhered to the liner 300.

The back surface of the first and third member 10, 30 of the label 100 is preferably deadened and the back surface of the second portion 20 includes an adhesive. When the release liner 300 is laminated to the back surface of the label 100, the first and third member 10, 30 non-permanently contacts the release liner 300 and the adhesive of the second member 20 are protected by the release liner. In embodiments where the back surface of the first member is covered with deadened material, the second and third members may be sized so they are sufficiently large to hold the label 100 onto the release liner with such strength to avoid the label 100 peeling from the release liner when the label 100 is printed. The release liner 300 may be removed from the label 100 just prior to application on a product 90.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention and of the manner and process of making and using it in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. An adhesive label comprising:
a substrate having opposing first and second surfaces, the substrate including:
a first member having opposing first and second surfaces and a continuous side edge;
a second member having opposing first and second surfaces, an inner continuous side edge and an outer continuous side edge wherein a portion of the inner continuous side edge is removably attached to a portion of the side edge of the first member; and
a third member having opposing first and second surfaces and a continuous side edge wherein a first portion of the side edge of the third member is removably attached to a portion of the side edge of the first member such that the third member is configured as a tear-away tab to provide access to an open side edge of the first member so as to enable detachment of the first member from the substrate.

2. An adhesive label as recited in claim 1 further including a release liner laminated to the substrate.

3. An adhesive label as recited in claim 1 wherein the second surface of the second member is provided with an adhesive.

4. An adhesive label as recited in claim 3 wherein the second surface of the first member is provided with a deadened surface.

5. An adhesive label as recited in claim 4 wherein the second surface of the third member is provided with a deadened surface.

6. An adhesive label as recited in claim 1 wherein machine formed perforations separate the first member from the second member.

7. An adhesive label as recited in claim 6 wherein machine formed perforations separate the third member from each of the first and second members.

8. An adhesive label as recited in claim 7 wherein the third member has a width greater than a width of the first member it is adjoined adjacent to.

9. An adhesive label as recited in claim 1 wherein a first surface of the first member is provided with printed indicia.

10. An adhesive label as recited in claim 9 wherein a second surface of the first member is provided with printed indicia.

11. An adhesive label as recited in claim 1 wherein a first surface of the second member is provided with printed indicia.

12. An adhesive label as recited in claim 1 wherein a first surface of the third member is provided with printed indicia.

13. An adhesive label as recited in claim 12 wherein a second surface of the third member is provided with printed indicia.

14. A releasable adhesive label comprising:
a release liner sheet;
a substrate sheet removably laminated to the release liner sheet, the substrate sheet having opposing first and second surfaces and further including:
a first member having opposing first and second surfaces and a continuous side edge wherein the second surface disposed adjacent the liner sheet is provided with a deadened surface and wherein each of the opposing first and second surfaces is provided with printed indica;
a second member having opposing first and second surfaces, an inner continuous side edge and an outer continuous side edge wherein a portion of the inner continuous side edge is removably attached to a portion of the side edge of the first member wherein the second surface of the second member disposed adjacent the liner sheet is provided with an adhesive; and
a third member having opposing first and second surfaces and a continuous side edge wherein a first portion of the side edge of the third member is removably attached to a portion of the side edge of the first member such that the third member is configured as a tear-away tab to provide access to an open side edge of the first member so as to enable detachment of the first member from the substrate and wherein the second surface of the third member disposed adjacent the liner sheet is provided with a deadened surface.

15. An adhesive label as recited in claim 14 wherein machine formed perforations separate the first member from the second member.

16. An adhesive label as recited in claim 15 wherein machine formed perforations separate the third member from each of the first and second members.

17. An adhesive label as recited in claim 14 wherein the third member has a width greater than a width of the first member it is adjoined adjacent to.

18. An adhesive label as recited in claim 14 wherein a first surface of the second member is provided with printed indicia.

19. An adhesive label as recited in claim 14 wherein a first surface of the third member is provided with printed indicia.

20. A method for manufacturing an adhesive label comprising:
providing a liner sheet
providing a substrate sheet laminated to the liner sheet, the substrate sheet having opposing first and second surfaces, the substrate including:
a first member having opposing first and second surfaces and a continuous side edge;
a second member having opposing first and second surfaces, an inner continuous side edge and an outer continuous side edge wherein a portion of the inner continuous side edge is removably attached to a portion of the side edge of the first member and wherein an adhesive is applied to the second surface of the second member; and
a third member having opposing first and second surfaces and a continuous side edge wherein a first portion of the side edge of the third member is removably attached to a portion of the side edge of the first member such that the third member is configured as a tear-away tab to provide access to an open side edge of the first member so as to enable detachment of the first member from the substrate; and
printing indicia on the second surface of the first member prior to the substrate being laminated to the liner sheet.
